(19) United States
(12) Patent Application Publication
(10) Pub. No.: US 2016/0377346 A1
(43) Pub. Date: Dec. 29, 2016

(54) HEAT TREATMENT APPARATUS

(71) Applicants: IHI Corporation, Tokyo (JP); IHI Machinery and Furnace Co., Ltd., Tokyo (JP)

(72) Inventors: Kazuhiko KATSUMATA, Inuyama-shi (JP); Kaoru ISOMOTO, Tokyo (JP); Takahiro NAGATA, Kamo-gun (JP); Akira NAKAYAMA, Hikari-shi (JP); Yuusuke SHIMIZU, Gifu-shi (JP); Gen NISHITANI, Kakamigahara-shi (JP)

(73) Assignees: IHI Corporation, Tokyo (JP); IHI Machinery and Furnace Co., Ltd., Tokyo (JP)

(21) Appl. No.: 15/259,183

(22) Filed: Sep. 8, 2016

Related U.S. Application Data
(63) Continuation of application No. PCT/JP2015/065063, filed on May 26, 2015.

(30) Foreign Application Priority Data
Jun. 26, 2014 (JP) 2014-131870

(51) Int. Cl. F27D 15/02; C21D 1/62

(52) U.S. Cl. CPC F27D 15/0206; C21D 1/62; F27D 2009/0081

(57) ABSTRACT

A heat treatment apparatus includes a cooling chamber configured to perform cooling of a treatment object, a conveyance chamber installed above the cooling chamber and configured to convey the treatment object, a lift table on which the treatment object is placed, and a lift mechanism having a driving apparatus installed above the lift table and configured to raise and lower the lift table between the cooling chamber and the conveyance chamber using the driving apparatus.

### TECHNICAL FIELD

Embodiments described herein relates to a heat treatment apparatus.

This application is a continuation application based on a PCT Patent Application No. PCT/JP2015/065063, filed on May 26, 2015, whose priority is claimed on Japanese Patent Application No. 2014-131870, filed on Jun. 26, 2014. The contents of both the PCT Application and the Japanese Application are incorporated herein by reference.

### BACKGROUND ART

In the related art, in order to perform treatment such as quenching or the like on a metal part serving as a treatment object, a heat treatment apparatus including a heating chamber and a cooling chamber is used. For example, Patent Document 1 discloses a heat treatment apparatus in which a plurality of heating chambers are formed above an intermediate conveyance chamber and a cooling chamber is formed below the intermediate conveyance chamber. In the heat treatment apparatus disclosed in Patent Document 1, a cylinder installed under the cooling chamber is used to deliver a treatment object between the intermediate conveyance chamber and the cooling chamber.

### CITATION LIST

### Patent Documents

Patent Document 1: Japanese Unexamined Patent Application, First Publication No. 2012-13341

### SUMMARY

However, when the cylinder is installed under the cooling chamber, overall dimensions of the heat treatment apparatus are increased by a height extent of the cylinder. As a result, the installation capacity of the heat treatment apparatus is increased.

The present disclosure has been made in view of the aforementioned problems, and an object of the present disclosure is to suppress a height dimension of a heat treatment apparatus to a low level and reduce the installation capacity of the heat treatment apparatus.

One aspect according to the present disclosure is a heat treatment apparatus including: a cooling chamber configured to perform cooling of a treatment object; a conveyance chamber which is installed above the cooling chamber and is configured to convey the treatment object; a lift table on which the treatment object is placed; and a lift mechanism which has a driving apparatus installed above the lift table and is configured to raise and lower the lift table between the cooling chamber and the conveyance chamber using the driving apparatus.

According to the present disclosure, a driving apparatus configured to raise and lower a lift table on which a treatment object is placed is installed above the lift table. For this reason, the lift mechanism including the driving apparatus is disposed to overlap the conveyance chamber installed above the cooling chamber in the height direction, and as a result, the height dimension of the heat treatment apparatus can be limited to a low level. Accordingly, according to the present disclosure, the height dimension of the heat treatment apparatus can be limited to a low level, and the installation capacity of the heat treatment apparatus can be reduced.

### BRIEF DESCRIPTION OF DRAWINGS

FIG. 1 is a plan view showing a schematic configuration of a multi-chamber heat treatment apparatus according to an embodiment of the present disclosure.

FIG. 2 is a cross-sectional view taken along line A-A of FIG. 1.

FIG. 3A is an enlarged view of a connecting place between an intermediate conveyance chamber penetrating pipe and a floor section of an intermediate conveyance chamber provided in the multi-chamber heat treatment apparatus according to the embodiment of the present disclosure.

FIG. 3B is a cross-sectional plan view including a tilt restricting mechanism provided in the multi-chamber heat treatment apparatus according to the embodiment of the present disclosure.

### DESCRIPTION OF EMBODIMENTS

Hereinafter, an embodiment of a heat treatment apparatus of the present disclosure will be described with reference to the accompanying drawings. In the following drawings, in order to provide members with recognizable sizes, the scales of the members may be appropriately varied.

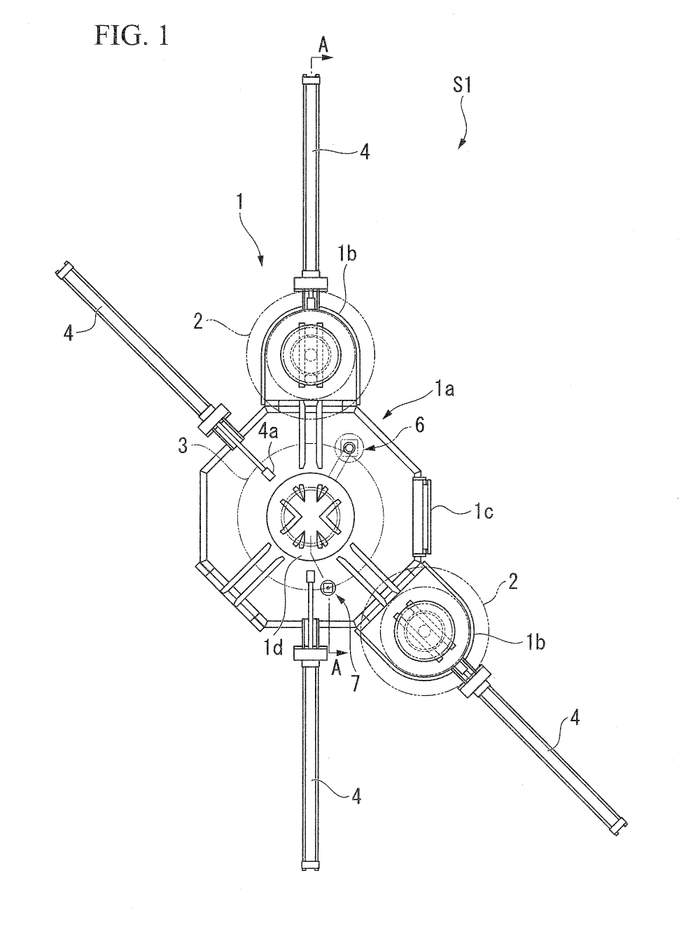

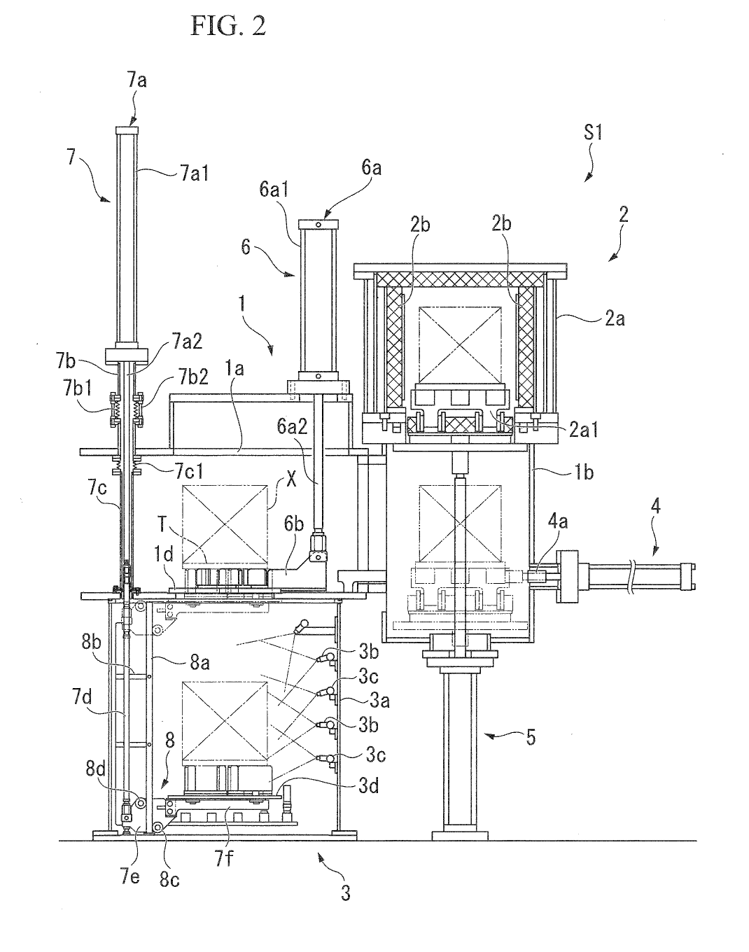

FIG. 1 is a plan view showing a schematic configuration of a multi-chamber heat treatment apparatus S1 (a heat treatment apparatus) of an embodiment. FIG. 2 is a cross-sectional view taken along line A-A of FIG. 1. As shown in the drawings, the multi-chamber heat treatment apparatus S1 of the embodiment is a heat treatment apparatus for performing quenching treatment with respect to a metal part serving as a treatment object X, and includes an intermediate conveyance chamber 1 (a conveyance chamber), a heating apparatus 2, a cooling apparatus 3, a horizontal conveyance mechanism 4, a lift mechanism 5 for a heating chamber, an upper lid lift mechanism 6, a lift mechanism 7 for a cooling chamber (a lift mechanism), and a tilt restricting mechanism 8.

The intermediate conveyance chamber 1 is disposed between the heating apparatus 2 and the cooling apparatus 3. The intermediate conveyance chamber 1 is a room configured to perform loading and unloading of the treatment object X with respect to the multi-chamber heat treatment apparatus S1 and to convey the treatment object X between the heating apparatus 2 and the cooling apparatus 3. The intermediate conveyance chamber 1 has a central chamber 1a and lift chambers lb for a heating chamber.

As shown in FIG. 1, the central chamber la has a substantially regular octagonal shape. The central chamber 1a is a room through which all of the treatment objects X treated by the multi-chamber heat treatment apparatus S1 of the embodiment pass. A loading/unloading door 1c serving as an entrance to the multi-chamber heat treatment apparatus S1 of the embodiment is installed at a sidewall of the central chamber 1a. The treatment object X is loaded into the central chamber 1a via the loading/unloading door 1c, and the treatment object X is unloaded from the central chamber 1a via the loading/unloading door 1c. In addition, the lift chambers lb for a heating chamber and the horizontal conveyance mechanisms 4 are attached to the sidewall of the central chamber 1a.

The cooling apparatus 3 is attached to a lower side of the central chamber 1a. An opening configured to bring the central chamber 1a (i.e., the intermediate conveyance chamber 1) in communication with a cooling chamber 3a (to be described below) of the cooling apparatus 3 is formed in a central section of a floor section of the central chamber 1a. The opening can be closed by an upper lid 1d that can be opened and closed. A rail is formed at an upper surface of the upper lid 1d to enable movement of the treatment object X via the rail of the upper lid 1d. The upper lid 1d is raised and lowered by the upper lid lift mechanism 6.

The lift chambers lb for a heating chamber are rooms configured to accommodate the treatment object X to be loaded from the intermediate conveyance chamber 1 into a heating chamber 2a (to be described below) or the treatment object X which has been unloaded from the heating chamber 2a into the intermediate conveyance chamber 1. The lift chamber 1b for a heating chamber can accommodate a floor section 2a1 of the heating chamber 2a that can be opened and closed, and accommodate the treatment object X placed on the floor section 2a1 together with the floor section 2a1. The floor section 2a1 is raised and lowered by the lift mechanism 5 for a heating chamber installed at each of the lift chambers 1b for a heating chamber. The horizontal conveyance mechanism 4 is attached to a sidewall of each of the lift chambers 1b for a heating chamber.

In the above-mentioned intermediate conveyance chamber 1, the heating apparatus 2 is installed above the lift chambers 1b for a heating chamber and the cooling apparatus 3 is installed below the central chamber 1a. That is, in the embodiment, the heating apparatus 2 is installed above the intermediate conveyance chamber 1, and the cooling apparatus 3 is installed below the intermediate conveyance chamber 1.

A gas supply apparatus (not shown) configured to supply an atmosphere foaming gas into the intermediate conveyance chamber 1 is connected to the intermediate conveyance chamber 1. Accordingly, for example, nitrogen gas serving as an atmosphere forming gas is supplied into the intermediate conveyance chamber 1. In addition, the atmosphere forming gas is also supplied into the cooling chamber 3a (to be described below) of the cooling apparatus 3 in addition to the intermediate conveyance chamber 1. In addition, a vacuum pump (not shown) configured to evacuate the inside of the intermediate conveyance chamber 1 is connected to the intermediate conveyance chamber 1.

The heating apparatus 2 includes the heating chambers 2a and heaters 2b. The heating chamber 2a is a cylindrical room configured to perform heating treatment of the treatment object X and installed over each of the lift chambers 1b for a heating chamber.

The multi-chamber heat treatment apparatus S1 of the embodiment includes two heating chambers 2a. The heaters 2b are installed in the heating chambers 2a. The treatment object X accommodated in the heating chamber 2a is heat-treated by heat generated from the heater 2b. The heater 2b may be an electro-thermal heater using nickel-chrome (Ni—Cr), molybdenum (Mo), or graphite as a heat generating body, a heater configured to perform heating using high frequency power, or the like. A gas supply apparatus (not shown) configured to supply an atmosphere forming gas into the heating chamber 2a is connected to the heating chamber 2a. For example, nitrogen gas and acetylene gas serving as atmosphere forming gasses are supplied into the heating chamber 2a. In addition, a vacuum pump for a heating chamber (not shown) configured to evacuate the inside of the heating chamber 2a is connected to each of the heating chambers 2a.

The cooling apparatus 3 includes the cooling chamber 3a, nozzles 3b, header pipes 3c, and a lift table 3d. The cooling chamber 3a is a heat treatment chamber configured to cool the treatment object X using latent heat of a mist serving as liquid particles and is connected to a lower side of the central chamber 1a of the intermediate conveyance chamber 1. That is, in the embodiment, the intermediate conveyance chamber 1 configured to convey the treatment object X is installed above the cooling chamber 3a.

A plurality of nozzles 3b are installed in the cooling chamber 3a to spray the mist into the cooling chamber 3a. The header pipes 3c are connected to the nozzles 3b to supply coolant to the nozzles 3b.

The treatment object X in the cooling chamber 3a is placed onto a tray T on the lift table 3d. The lift table 3d can be raised and lowered by the lift mechanism 7 for a cooling chamber. In a state in which the lift table 3d is mostly raised, the lift table 3d closes the opening formed in the central section of the floor section of the central chamber 1a. A rail is installed at an upper surface of the lift table 3d. The rail is inserted into the central chamber la when the lift table 3d closes the opening formed in the central section of the floor section of the central chamber 1a. For this reason, when the lift table 3d closes the opening formed in the central section of the floor section of the central chamber 1a, movement of the treatment object X becomes possible via the rail of the lift table 3d.

The cooling apparatus 3 also includes a coolant collecting/supply apparatus (not shown) configured to collect coolant from the cooling chamber 3a, cool the coolant again, and supply the cooled coolant into the header pipe 3c, and a vacuum pump configured to evacuate the inside of the cooling chamber 3a.

The horizontal conveyance mechanisms 4 are attached to the sidewall of the central chamber 1a and the sidewalls of the lift chambers 1b for a heating chamber as described above. Each of the horizontal conveyance mechanisms 4 includes a rod 4a configured to push the treatment object X forward in a horizontal direction along the rail installed in the intermediate conveyance chamber 1 by pressing the tray T on which the treatment object X is placed. The treatment object X in the intermediate conveyance chamber 1 is moved in the horizontal direction by the horizontal conveyance mechanism 4.

The lift mechanism 5 for a heating chamber is attached to the lower side of each of the lift chambers 1b for a heating chamber. The lift mechanism 5 for a heating chamber is constituted by a lift cylinder configured to raise and lower the floor section 2a1 of the heating chamber 2a. Together with the floor section 2a1, the treatment object X is raised and lowered between the heating chamber 2a and the lift chamber 1b for a heating chamber by the lift mechanism 5 for a heating chamber.

As shown in FIG. 2, the upper lid lift mechanism 6 includes a lift cylinder 6a for an upper lid and a connecting section 6b. The lift cylinder 6a for an upper lid includes a cylinder case 6a1 protruding upward from the intermediate conveyance chamber 1 and a rod 6a2 extendable downward, and is fixed to the cooling chamber 3a. The connecting section 6b is connected to a side surface of the upper lid 1d and a tip of the rod 6a2, and therefore indirectly connects the upper lid 1d to the rod 6a2. The connecting section 6b is connected to the rod 6a2 such that the upper lid 1d can be slightly tilted in an upward/downward direction about a connecting place between the connecting section 6b and the rod 6a2.

The upper lid lift mechanism 6 performs elevation of the upper lid 1d under control of a control device (not shown). For example, when the lift table 3d is lowered by the lift mechanism 7 for a cooling chamber, the upper lid lift mechanism 6 lowers the upper lid 1d to close the opening formed in the central section of the floor section of the central chamber 1a using the upper lid 1d. When the lift table 3d is raised by the lift mechanism 7 for a cooling chamber, the upper lid lift mechanism 6 raises the upper lid 1d.

The lift mechanism 7 for a cooling chamber includes a lift cylinder 7a for a cooling chamber, a cylinder attachment pipeline 7b, an intermediate conveyance chamber penetrating pipe 7c, a lift table rod 7d, a connecting section 7e, and a lift table receiving section 7f. The lift cylinder 7a for a cooling chamber includes a cylinder case 7a1 fixed to the cooling chamber 3a via the cylinder attachment pipeline 7b and protruding upward from the intermediate conveyance chamber 1, and a rod 7a2 extendable downward. The rod 7a2 of the lift cylinder 7a for a cooling chamber is formed to pass through a ceiling section of the intermediate conveyance chamber 1.

The cylinder attachment pipeline 7b is a pipeline that surrounds the rod 7a2 and is interposed between the lift cylinder 7a for a cooling chamber and the cooling chamber 3a. The cylinder attachment pipeline 7b is disposed coaxially with the lift cylinder 7a for a cooling chamber and has a bellows 7b1 formed in the middle thereof. The cylinder attachment pipeline 7b includes a bolt 7b2 that connects an upper portion and a lower portion of the cylinder attachment pipeline 7b spanning the bellows 7b1 in a height direction. As a tightening amount of a nut with respect to the bolt 7b2 is adjusted, a positional relation between the upper portion and the lower portion of the cylinder attachment pipeline 7b can be adjusted. Accordingly, even when an attachment error or a form error of the lift cylinder 7a for a cooling chamber or the cylinder attachment pipeline 7b is large, the rod 7a2 can be prevented from interfering with the cylinder attachment pipeline 7b.

The intermediate conveyance chamber penetrating pipe 7c is a pipeline that surrounds the rod 7a2, and is connected to a lower portion of the cylinder attachment pipeline 7b. The intermediate conveyance chamber penetrating pipe 7c passes through the intermediate conveyance chamber 1 in a vertical direction, and has a bellows 7c1 installed at an upper portion thereof. The upper portion of the intermediate conveyance chamber penetrating pipe 7c at which the bellows 7c1 is installed is fixed to the ceiling section of the intermediate conveyance chamber 1, and the lower portion of the intermediate conveyance chamber penetrating pipe 7c is fixed to the floor section of the intermediate conveyance chamber 1.

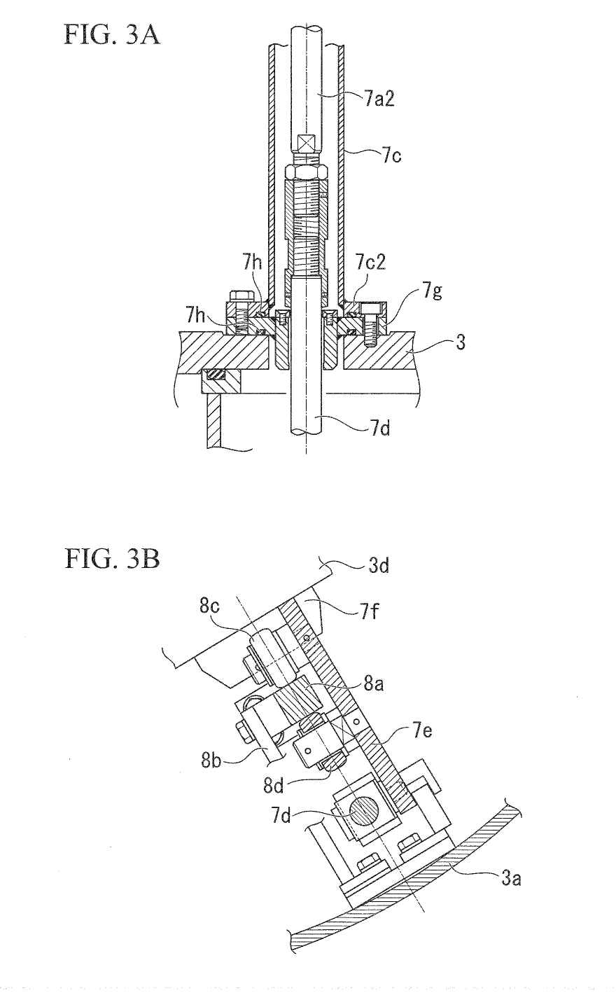

FIG. 3A is an enlarged view of a connecting place between the intermediate conveyance chamber penetrating pipe 7c and the floor section of the intermediate conveyance chamber 1. As shown in FIG. 3A, the intermediate conveyance chamber penetrating pipe 7c has a flange 7c2 formed at a lower end thereof, and the flange 7c2 is fixed to the floor section of the intermediate conveyance chamber 1 via a rod guide flange 7g. O-rings 7h are interposed between the flange 7c2 and the rod guide flange 7g and between the rod guide flange 7g and the floor section of the intermediate conveyance chamber 1.

Since the inside of the intermediate conveyance chamber penetrating pipe 7c and the inside of the intemiediate conveyance chamber 1 are isolated by the O-rings 7h, there is no need to install a seal section, which may be formed by providing sliding places, between the rod 7a2 or the lift table rod 7d and the intermediate conveyance chamber penetrating pipe 7c, and a gas in the cooling chamber 3a can be easily prevented from leaking into the intermediate conveyance chamber 1.

As shown in FIG. 3A, the upper end of the lift table rod 7d is connected to the lower end of the rod 7a2 of the lift cylinder 7a for a cooling chamber so as to substantially downwardly extend the rod 7a2 of the lift cylinder 7a for a cooling chamber. The connecting section 7e is connected to a side surface of the lift table receiving section 7f and a tip of the lift table rod 7d, and therefore indirectly connects the lift table receiving section 7f to the lift table rod 7d. The connecting section 7e is connected to the lift table rod 7d such that the lift table receiving section 7f can be slightly tilted about a connecting place between the connecting section 7e and the lift table rod 7d in the upward/downward direction. The lift table receiving section 7f supports the lift table 3d and is fixed to the lift table 3d from below.

The lift mechanism 7 for a cooling chamber performs elevation of the lift table 3d under control of the control device (not shown).

For example, the lift mechanism 7 for a cooling chamber raises the lift table 3d to dispose the lift table 3d in the intermediate conveyance chamber 1 in the case where the treatment object X is placed on the lift table 3d in the intermediate conveyance chamber 1 and in the case where the treatment object X placed on the lift table 3d is moved. The lift mechanism 7 for a cooling chamber lowers the lift table 3d to dispose the intermediate conveyance chamber 1 in the cooling chamber 3a in the case where the treatment object X is cooled.

The tilt restricting mechanism 8 includes a lift guide 8a (a guide), a support section 8b, a first roller 8c, and a second roller 8d. FIG. 3B is a cross-sectional plan view including the tilt restricting mechanism 8. The lift guide 8a is a rod-shaped guide vertically installed in the cooling chamber 3a, and as shown in FIG. 3B, is disposed in the vicinity of the lift table rod 7d. The support section 8b connects the lift guide 8a and a wall surface of the cooling chamber 3a, and supports the lift guide 8a so that the lift guide 8a is not tilted. The first roller 8c and the second roller 8d are a pair of rollers disposed to sandwich the lift guide 8a therebetween and be rollable with respect to the lift guide 8a. As shown in FIG. 2, the first roller 8c is disposed between the lift guide 8a and the lift table receiving section 7f, is disposed below the second roller 8d, and is rotatably attached to a side surface of the connecting section 7e. The second roller 8d is disposed between the lift guide 8a and the lift table rod 7d, is disposed above the first roller 8c, and is rotatably attached to the side surface of the connecting section 7e. When the connecting section 7e is raised and lowered by expansion and contraction of the lift cylinder 7a for a cooling chamber, the first roller 8c and the second roller 8d move in the upward/downward direction while rolling on a side surface of the lift guide 8a.

According to the above-mentioned tilt restricting mechanism 8, since the lift guide 8a is sandwiched and supported by the first roller 8c and the second roller 8d, a load in the horizontal direction generated when the treatment object X is placed on the lift table 3d and applied to the lift table receiving section 7f can be received by the lift guide 8a, and tilting of the lift table 3d with respect to a horizontal surface is restricted. Accordingly, according to the tilt restricting mechanism 8, a burden of a connecting place between the lift table receiving section 7f and the connecting section 7e is reduced.

Heating treatment of the treatment object X by the multi-chamber heat treatment apparatus S1 having the above-mentioned configuration is performed under control of the control device (not shown). First, the treatment object X is loaded into the central chamber 1a of the intermediate conveyance chamber 1, and then, the treatment object X is horizontally conveyed into the lift chamber 1b for a heating chamber by the horizontal conveyance mechanism 4. Next, the treatment object X is raised to the heating chamber 2a by the lift mechanism 5 for a heating chamber, and heating treatment of the treatment object X is performed in the heating apparatus 2.

When the heating treatment of the treatment object X is completed, the treatment object X is lowered to the lift chamber 1b for a heating chamber by the lift mechanism 5 for a heating chamber. Here, the upper lid 1d is raised by the upper lid lift mechanism 6, and the lift table 3d is raised by the lift mechanism 7 for a cooling chamber to dispose the lift table 3d in the central chamber 1a of the intermediate conveyance chamber 1. Then, the treatment object X which has been lowered to the lift chamber 1b for a heating chamber is horizontally conveyed onto the lift table 3d by the horizontal conveyance mechanism 4.

Next, the lift table 3d is lowered into the cooling chamber 3a by the lift mechanism 7 for a cooling chamber, and the upper lid 1d is closed by the upper lid lift mechanism 6. After that, cooling treatment of the treatment object X is performed in the cooling apparatus 3. When the cooling treatment is completed, the upper lid 1d is raised by the upper lid lift mechanism 6, the lift table 3d is raised by the lift mechanism 7 for a cooling chamber, and then, the treatment object X is horizontally conveyed to a discharge position by the horizontal conveyance mechanism 4.

According to the multi-chamber heat treatment apparatus S1 of the embodiment as described above, the lift cylinder 7a for a cooling chamber configured to raise and lower the lift table 3d on which the treatment object X is placed is installed above the lift table 3d. For this reason, the lift mechanism 7 for a cooling chamber is disposed to overlap the intermediate conveyance chamber 1 installed above the cooling chamber 3a in the height direction, and as a result, the height dimension of the multi-chamber heat treatment apparatus S1 can be limited to a low level. Further, according to the multi-chamber heat treatment apparatus S1 of the embodiment, as shown in FIG. 2, since the lift cylinder 7a for a cooling chamber is installed to overlap the heating apparatus 2 in the height direction, an increase in the height dimension by installing the lift cylinder 7a for a cooling chamber can be maximally limited. Accordingly, according to the multi-chamber heat treatment apparatus S1 of the embodiment, the height dimension can be limited to a low level and an installation capacity can be reduced.

In addition, in the multi-chamber heat treatment apparatus S1 of the embodiment, the lift mechanism 7 for a cooling chamber includes the lift cylinder 7a for a cooling chamber installed to pass through the ceiling section of the intermediate conveyance chamber 1, and the connecting section 7e configured to support the lift table 3d and connect the lift cylinder 7a for a cooling chamber and the lift table 3d. According to the multi-chamber heat treatment apparatus S1 of the above-mentioned embodiment, the lift cylinder 7a for a cooling chamber can be installed, by using the connecting section 7e, at a position deviated from the lift table 3d when seen from above. Accordingly, the degree of freedom of disposition of the lift cylinder 7a for a cooling chamber can be improved, and the lift cylinder 7a for a cooling chamber or the intermediate conveyance chamber penetrating pipe 7c can be installed at a position having no influence on conveyance of the treatment object X.

In addition, in the multi-chamber heat treatment apparatus S1 of the embodiment, the tilt restricting mechanism 8 configured to restrict tilting of the lift table 3d with respect to the horizontal surface is provided. For this reason, the lift table 3d can be stably cantilevered by installing the lift cylinder 7a for a cooling chamber at only one side of the lift table 3d when seen from above.

In addition, in the multi-chamber heat treatment apparatus S1 of the embodiment, the tilt restricting mechanism 8 includes the lift guide 8a vertically installed at the cooling chamber 3a, and the pair of rollers (the first roller 8c and the second roller 8d) rollable on the lift guide 8a with the lift guide 8a sandwiched therebetween and rotatably attached to the connecting section 7e of the lift mechanism 7 for a cooling chamber. For this reason, the tilting of the lift table 3d can be prevented using a simple structure without using a separate driving mechanism or the like.

Hereinabove, while the exemplary embodiment of the present disclosure has been described with reference to the accompanying drawings, the present disclosure is not limited to the above-mentioned embodiment. All of the shapes or combinations of the components shown in the above-mentioned embodiment are exemplarily provided, and various modifications may be made based on design requirements or the like without departing from the spirit of the present disclosure.

For example, in the embodiment, an example of applying the present disclosure to the multi-chamber heat treatment apparatus S1 having two heating apparatuses has been described. However, the present disclosure is not limited thereto but may be applied to a general heat treatment apparatus in which a conveyance chamber is provided above a cooling apparatus.

In addition, in the embodiment, the configuration in which the lift table 3d is raised and lowered using the lift cylinder 7a for a cooling chamber as the driving apparatus. However, the present disclosure is not limited thereto but a configuration in which the lift table 3d is raised and lowered using another driving apparatus may be employed.

### INDUSTRIAL APPLICABILITY

According to the present disclosure, a height dimension of the heat treatment apparatus can be limited to a low level and the installation capacity of the heat treatment apparatus can be reduced.

What is claimed is:

1. A heat treatment apparatus comprising:
a cooling chamber configured to perform cooling of a treatment object;
a conveyance chamber which is installed above the cooling chamber and is configured to convey the treatment object;
a lift table on which the treatment object is placed; and
a lift mechanism which has a driving apparatus installed above the lift table and is configured to raise and lower the lift table between the cooling chamber and the conveyance chamber using the driving apparatus.

2. The heat treatment apparatus according to claim 1, wherein the lift mechanism includes:
a cylinder serving as the driving apparatus and installed to pass through a ceiling section of the conveyance chamber; and
a connecting section configured to support the lift table and connect the cylinder and the lift table.

3. The heat treatment apparatus according to claim 1, further comprising a tilt restricting mechanism configured to restrict tilting of the lift table with respect to a horizontal surface.

4. The heat treatment apparatus according to claim 2, further comprising a tilt restricting mechanism configured to restrict tilting of the lift table with respect to a horizontal surface.

5. The heat treatment apparatus according to claim 3, wherein the tilt restricting mechanism includes:
a guide vertically installed in the cooling chamber; and
a pair of rollers rollable on the guide with the guide sandwiched therebetween and rotatably attached to the lift mechanism.

6. The heat treatment apparatus according to claim 4, wherein the tilt restricting mechanism includes:
a guide vertically installed in the cooling chamber; and
a pair of rollers rollable on the guide with the guide sandwiched therebetween and rotatably attached to the lift mechanism.
